(19) United States
(12) Patent Application Publication
(10) Pub. No.: US 2013/0265478 A1
(43) Pub. Date: Oct. 10, 2013

(54) CAMERA OBJECTIVE LENS WITH INFRARED FILTER AND CAMERA MODULE WITH CAMERA OBJECTIVE LENS

(71) Applicant: SCHOTT AG, Mainz (DE)

(72) Inventors: Steffen REICHEL, Mehlingen (DE); Frank-Thomas LENTES, Bingen (DE); Karl MENNEMANN, Taunusstein (DE)

(73) Assignee: Schott AG, Mainz (DE)

(21) Appl. No.: 13/859,973

(22) Filed: Apr. 10, 2013

(30) Foreign Application Priority Data
Apr. 10, 2012 (DE) 10-2012-103-076.6

(51) Int. Cl. G02B 9/04; H04N 5/225

(52) U.S. Cl. CPC G02B 9/04; H04N 5/2254
USPC 348/340; 359/795; 65/66

(57) ABSTRACT

A lens system having an infrared filter for a compact camera module is provided. The lens system is an achromatic lens system and has two lenses. The first lens has a positive focal length, and the second lens has a negative focal length. The first lens is made of copper ion containing glass which absorbs infrared light and functions as an infrared filter. The second lens has an Abbe number that is smaller than that of the first lens with a difference between the Abbe numbers of the first lens and the second lens being at least 15.

### CROSS REFERENCE TO RELATED APPLICATIONS

This application claims benefit under 35 U.S.C. §119(a) of German Patent Application No. 10-2012-103-076.8, filed Apr. 10, 2012, the entire contents of which are incorporated herein by reference.

### BACKGROUND OF THE INVENTION

1. Field of the Invention

The invention generally relates to objective lenses for camera. More particularly, the invention relates to an infrared filter for camera modules which filters out infrared components of the light in front of the camera sensor.

2. Description of Related Art

As is known, camera sensors typically have the property that the pixels of the sensor are sensitive also in the infrared spectral range. Moreover, the optical system of camera modules whose optical components are made from standard glasses or plastic materials generally exhibit a certain amount of infrared transmission. However, infrared light that reaches the sensor results in undesirable color and brightness distortions.

For this reason, camera modules are typically equipped with infrared filters. The most common infrared filters are interference filters. For such filters, a multi-layered dielectric layer system is deposited on a substrate, typically a glass substrate. The multi-layered dielectric layer system is designed to reflect infrared radiation, but to transmit visible light. Such filters are relatively inexpensive to produce, but have several drawbacks. Interference filters often impart a certain modulation to the transmission curve. This modulation has an effect similar to that of a comb filter and may affect individual colors.

Moreover, interference layers exhibit a much greater angle dependence of the filter curve (transmission spectrum) than infrared filters made of filter glass.

Additionally, the infrared light is reflected back by the interference layer into the optical system. Since the interference filter generally still exhibits residual transmission at least in the near infrared range, ghost images may occur in the optical system due to multiple reflections.

An alternative thereto is provided by infrared filters in form of filter glasses. A filter glass, by virtue of its character, neither exhibits the aforementioned comb filter effect nor ghost images due to multiple reflected infrared light, since the infrared light is absorbed when passing through the glass. Typically, such filters are placed on the sensor in the form of thin glass sheets, similar to interference filters. Furthermore, it is known from U.S. Pat. No. 7,618,909 B2 and U.S. 2007/0051930 A1 to produce lenses from filter glasses by blank molding.

Independent of its structural design, the infrared filter occupies space. However, especially in small camera modules such as used in cell phones, for example, the space available for the camera module is very limited. This problem is even exacerbated with the short focal lengths nowadays demanded for objective lenses. Moreover, even with small and inexpensive optic systems of such modules, good image quality is desired. Therefore, it would be desirable to be able to design the optical system of a camera module even more compact, without sacrificing an infrared filter, while improving the optical properties of such camera modules.

### SUMMARY

Accordingly, the invention provides a lens system for a camera module, or an objective lens for a camera module, wherein the lens system is an achromatic lens system and comprises two lenses.

One of the lenses has a positive focal length and therefore is a converging lens or positive lens. This lens is referred to as a first lens below. A further lens has a negative focal length and therefore is a negative lens or diverging lens. This lens is referred to as a second lens below. The terms “first lens” and “second lens” herein do not refer to the sequence within the lens system but are used to distinguish the two lenses, and to distinguish these lenses from optionally provided additional lenses, which may be converging and/or diverging lenses.

The first lens is made of copper ions containing glass which absorbs infrared light and thus forms an infrared filter, or functions as an infrared filter. The second lens with negative focal length has a smaller Abbe number than the first lens with positive focal length, and the difference between the Abbe numbers of the first lens and the second lens is at least 15. If the lens doublet is to have a focusing effect, the absolute value of the focal length of the second lens is smaller than the focal length of the first lens. This embodiment of the invention is preferred, especially to be able to realize short focal lengths.

In this way, an otherwise common infrared filter in form of a separate sheet, either in form of an absorbing sheet or of a dielectric interference layer system in front of the sensor, may now be omitted. Moreover, at the same time, with the filter glass used an achromat is formed. Therefore, the invention permits to reduce the number of optical components. Also, the space that is otherwise occupied by the infrared filter, may now be utilized for other purposes. For example, the entire objective lens can be shortened and hence a corresponding camera module may be downsized on the whole. Also, when a separate infrared filter sheet is eliminated, production cost is reduced.

An infrared filter, herein, is generally understood as an optical element which is arranged in the beam path in front of the sensor, so that the light beams which are detected by the sensor pass through this optical element, and wherein the transmission of the optical element is lower by at least a factor of −8 at a wavelength of 850 nanometers than at a wavelength of 500 nanometers, with a thickness of the filter glass of 0.3 mm.

The first and the second lens together form an achromatic lens system. It is surprising in this context that a copper containing glass which has a significant absorption at least in the near infrared range adjacent to the visible spectral range, may exhibit such a low dispersion that a difference in the Abbe numbers of the two lenses can be obtain which is sufficient for a good chromatic correction.

In particular, such a copper ions containing and infrared light absorbing glass of the first lens may even have an Abbe number of at least 55, preferably at least 60.

High Abbe numbers may in particular be achieved by using copper ions containing phosphate or fluorophosphate glass for the first lens.

The Abbe number is specified as a dimensionless parameter

$${v}_{d} = \frac{{n}_{d} - 1}{{n}_{F} - {n}_{C}} ,$$

wherein n_{d} designates the refractive index at a wavelength of light of about 587 nm, n_{F} designates the refractive index at a wavelength of light of about 486 nm, and n_{C} designates the refractive index at a wavelength of light of about 656 nm.

However, infrared filter glasses which are often referred to as blue glasses, may contain streaks to some extent, also known as schlieren in the art. Schlieren are defined in DIN/ISO 10110-4. These have less optical effect, when the infrared filter is arranged near the sensor. If, however, as suggested according to the invention, the filter glass is used as a lens, this typically results in a larger distance of the filter glass to the sensor. Due to the increased distance, local changes in the refractive index of the glass which are caused by schlieren have a stronger light deflecting effect. Therefore, according to one embodiment of the invention, a low schlieren glass is used for the first lens, so that the wavefront error caused by schlieren is not greater than 30 nanometers, preferably not greater than 15 nanometers. The wavefront error is defined according to DIN/ISO 10110-14. The wavefront error or wavefront distortion may be measured according to DIN/ISO 14999-4. The wavefront error is preferably measured using light having a wavelength of 546.07 nm.

To produce such low schlieren glasses in form of infrared filter glasses, again, phosphate glasses are suitable, and especially fluorophosphate glasses. Fluorophosphate glasses are even more suitable for the invention than phosphate glasses because it has been found that fluorophosphate glasses exhibit a higher corrosion resistance. This is relevant in case the filter glass is not applied to the sensor and better protected from environmental influences by the other optical components. If the glass is used in form of a lens, the glass is more exposed to corrosive influences. This is in particular the case when the first lens is the frontmost lens, i.e. the lens at the light entrance side.

Phosphate glasses, herein, refer to optical glasses in which P₂O₅ functions as a glass former and is present in the glass as a major component. When replacing a portion of the phosphate in a phosphate glass by fluorine, fluorophosphate glasses are obtained. For the synthesis of fluorophosphate glasses, instead of oxide compounds such as NaO₂, the corresponding fluorides such as NaF are added to the glass batch.

A phosphate glass or a fluorophosphate glass is very suitable for the first lens, both in terms of a high Abbe number and in view of a low schlieren optical component.

For the second lens, a flint glass is useful. A flint glass refers to a glass having an Abbe number smaller than 50. However, a plastic material having a sufficiently high dispersion is likewise conceivable in combination with the first lens of infrared absorbing glass, to obtain an achromatic lens system according to the invention. Preferably, the flint glass of the second lens has a higher refractive index than the copper containing glass of the first lens.

Furthermore, it is advantageous to have the first lens arranged at the light entrance side. Although, on the one hand, this increases the light deflecting effect of schlieren, since the distance to a sensor arranged at the light exit side increases, the focal length is shortened on the other hand. Especially, the first lens may advantageously serve as the entrance lens of the lens system, i.e. the first lens through which the light rays will pass on their way to the sensor of a camera module that includes the lens system according to the invention.

In the simplest case, the lens system comprises only the first and the second lens. However, for beneficial imaging properties and/or for shortening the focal length, it is advantageous to provide one or more additional lenses.

The invention also relates to a camera module comprising a semiconductor array sensor and lens system according to the invention as described above, which is arranged in front of, i.e. upstream the semiconductor array sensor.

As also described above, advantageously the first lens is arranged at the light entrance side with respect to the second lens. If further lenses are provided in the lens system, it is advantageous for the achromatic properties of the lens system and accordingly for the optical resolution of a camera module including the lens system, to have the first and second lenses arranged directly one behind the other. In other words, according to one embodiment of the lens system and the camera module including this lens system, at least one, preferably two further lenses are provided in addition to the first and the second lens, the first and the second lens being arranged to directly follow one another along the optical path.

### BRIEF DESCRIPTION OF THE DRAWINGS

The invention will now be described in more detail by way of exemplary embodiments and with reference to the accompanying drawings. In the drawings, the same reference numerals designate the same or corresponding elements. In the drawings:

FIG. 1 illustrates a camera module comprising a lens system according to the invention, and three light beams focused onto the sensor of the camera module from different angles, by the lens system;

FIGS. 2, 3, and 4 show focal spots of light beams for ideal schlieren-free optical components of a lens system as shown in a similar form in FIG. 1;

FIG. 5 shows a model of a lens surface with waves;

FIGS. 6, 7, 8 show, in correspondence to FIGS. 2, 3, 4, focal spots of light beams of the lens system including a lens modified according to FIG. 5; and

FIG. 9 shows transmission characteristics of the entire optical camera module without anti-reflective coatings for a blue glass filter sheet and a blue glass lens when using the same blue glass (same copper ion concentration).

### DETAILED DESCRIPTION

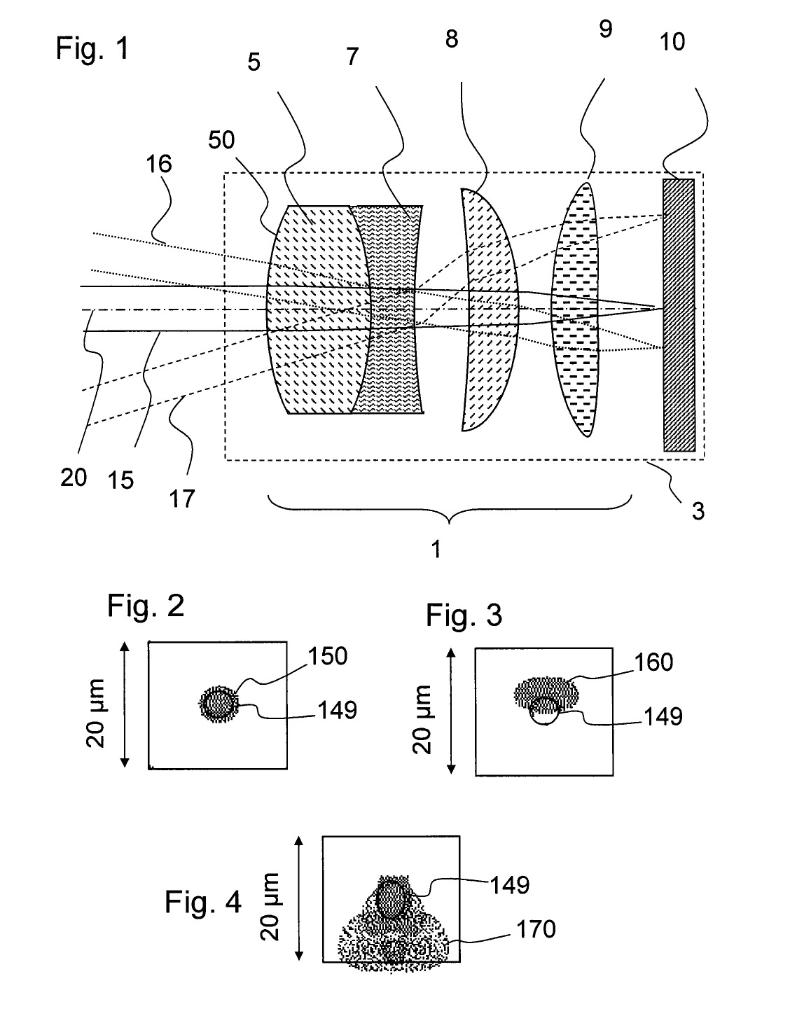

The camera module 3 as shown in FIG. 1 comprises a lens system 1 and a semiconductor array sensor 10. Lens system 1 is arranged in front of semiconductor array sensor 10 and focuses incident light onto semiconductor array sensor 10. For clarification purposes, three beams of light rays 15, 16, 17 are illustrated. These light ray beams 15, 16, 17 are beams of parallel rays incident at different angles. Accordingly, the beam path illustrated corresponds to an imaging of very distant objects. Beam 15, herein, is a bundle of paraxial light rays.

The other beams 16, 17, by contrast, are incident at an angle to the optical axis 20. The angle of beam 17 to the optical axis corresponds to that of the light that is incident on the edge of semiconductor array sensor 10. Furthermore, in the illustration of FIG. 1, the angle of beam 16 is selected such that the light is focused onto a region between the center and the edge of semiconductor array sensor 10. By way of these three beams 15, 16, 17, the influence of schlieren on the resolution of camera module 3 will be explained below.

Lens system 1 comprises a first lens 5 with a positive focal length. In this embodiment, the first lens is designed as a biconvex lens. First lens 5 is disposed at the light entrance side and is the first lens through which the light passes on its way to the semiconductor array sensor. In other words, first lens 5 forms the entrance lens of lens system 1.

Directly downstream a second lens 7 is arranged, which has a negative focal length. In the exemplary embodiment shown in FIG. 1, second lens 7 is designed as a biconcave lens. The two lenses 5, 7 together form an achromat as a part of lens system 1. For this purpose, it is advantageous if the two lenses 5, 7 are sequentially arranged in the beam path, i.e. adjacent to one another along the beam path. The two lenses 5, 7 may be placed directly one adjacent the other without an air gap therebetween, as in the illustrated exemplary embodiment. This is advantageous in order to reduce reflection losses, and to allow to omit an anti-reflection coating of lenses 5 and 7 at their mutual interface. However, it is also possible to provide an air gap between the two adjacent lenses 5, 7. This expands the possibilities to correct chromatic errors of higher order, but on the other hand increased reflection losses and increases adjustment and assembly complexity.

Furthermore, the lens pair of first lens 5 and second lens 7 together is intended have a focusing effect. Therefore, the shape of the refractive surfaces of lenses 5, 7 is chosen, while taking into account the respective refractive indices, such that the absolute value of the negative focal length of second lens 7 is smaller than the positive focal length of first lens 5.

Two further lenses 8, 9 serve to shorten the focal length and for further correction of monochromatic aberrations such as spherical errors, distortions, and coma. To this end, at least one of the two further lenses 8, 9 may be an aspherical lens, without being limited to the particular example illustrated.

According to the invention, first lens 5 is made of copper ions containing glass which absorbs infrared light and acts as an infrared filter. Despite the absorption of the copper ions in the near infrared range, which influences spectral transmission, the Abbe number is greater than the Abbe number of the second lens by at least 15.

Since, surprisingly, it has been found that copper ions containing glass may have an Abbe number of at least 60, this allows to use a flint glass for the second lens 7 in order to achieve sufficient chromatic correction. At the same time, excellent color correction is achieved due to the infrared filter effect of the first lens 5. A flint glass is preferred for the second lens 7 in order to achieve a strong dispersion. The Abbe number of the second lens 7 is preferably smaller than 50. Furthermore preferably, the refractive index of the second lens 7 is at least 1.5.

The effect of the lens pair as an achromatic correction element may be further enhanced by selecting a material with a small Abbe number. Generally, without limitation to the specific lens system 1 shown in FIG. 1, the Abbe number of the second lens 7 preferably has a value of not more than 40, or of even less than 30.

Glasses having such low Abbe numbers are available in the market at reasonable prices. In particular heavy flint glasses, lanthanum heavy flint glasses, and lanthanum flint glasses can be considered here. To give an example, an optical glass of the Applicant marketed under the trade name N-SF6 may be mentioned, which has an Abbe number of 25.4 and a refractive index of n_{d}=1.8052. Another example is the heavy flint glass marketed by the Applicant under the trade name N-SF2, having an Abbe number of 33.8 and a refractive index of n_{d}=1.6477.

For the first lens, in order to achieve a high Abbe number phosphate glasses are suitable, in particular fluorophosphate glasses, despite of the infrared absorbing copper ions.

CuO-doped fluorophosphate glasses with different CuO concentrations and hence different absorption properties include, for example, the glasses BG60, BG61, or as phosphate glasses, BG39, BG18, BG55 of SCHOTT AG.

However, especially in glasses containing copper ions such as used in the invention for the first lens 5, schlieren may be formed in the manufacture of the glass. Schlieren represent local variations in chemical composition and thus also cause a local change of the refractive index of the glass. Associated therewith are distortions of the wavefronts which may be measured according to DIN/ISO 14999-4 and thus corresponding deflections of light rays. Even if these deflections from the intended path are small, they continue to grow with the distance to the sensor. Therefore, with an infrared filter sheet of blue glass arranged in front of the sensor, typically only strong schlieren become noticeable. On the other hand, it has been found that the negative effect of schlieren is significantly stronger in a lens of a lens system according to the invention. The effect of schlieren will now be explained in more detail by way of a simulation.

For this purpose, FIGS. 2, 3, and 4 show the focuses of the three light beams 15, 16, 17 produced by lens system 1 on semiconductor array sensor 10 with ideal schlieren-free optical components. The focuses were calculated using a simulation program. Each of the Figures shows an area sized 20 μm×20 μm of the surface of semiconductor array sensor 10. FIG. 2 shows the focus 150 of paraxial light beam 15. For comparison, an ideal diffraction-limited focus (so-called Airy disk) is shown designated with the reference numeral 149. The comparison of focuses 149, 150 makes clear that focus 150 of lens system 1 is only slightly greater than the optimally achievable focus, or Airy disk, of an ideal optical system.

For the middle light beam 16 incident between the center and the edge of semiconductor array sensor 10, the focus 160 thereof as illustrated in FIG. 3 already shows a slight coma. However, similar to focus 150 produced in the center of the sensor, there is no significant lateral chromatic error detected. The illustrated focuses 150, 160, therefore, substantially apply for red and green and blue light.

FIG. 4 shows the focus 170 of light beam 17 which is focused onto the edge of semiconductor array sensor 10. Here it can be seen that the focus 149 of an ideal diffraction-limited optical system exhibits a slight coma and therefore is somewhat oval. The real focus 170 is already much larger. Additionally, a color error is revealed herein, with the lower portions of focus 170 shown in FIG. 4 primarily containing blue components. This is because the underlying optical system of the exemplary embodiment does not completely correct the lateral chromatic aberration.

In order to assess the effect of schlieren, instead of a wavefront deformation generated by a schliere in the interior of the glass, an equivalent wavefront deformation may be produced by a ripple on the surface. Thus, for the simulation a lens 5 is assumed having a ripple on the lens surface 50.

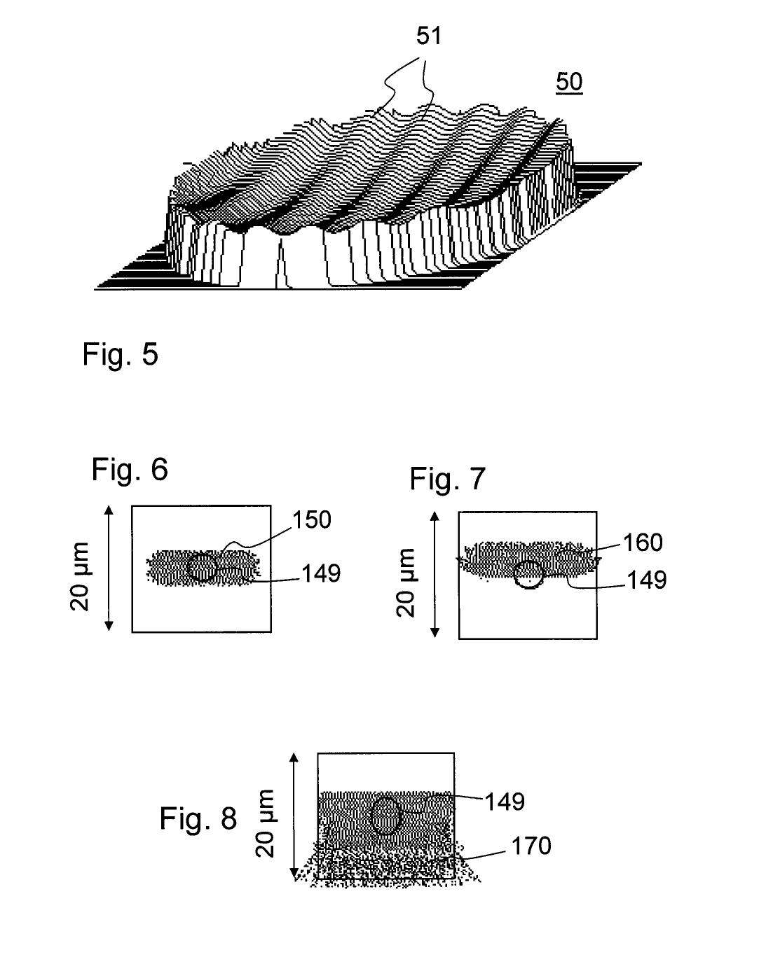

FIG. 5 shows the model of the lens surface 50 on which the simulation is based. In FIG. 5, waves 51 are exaggerated and were assumed to run in one direction, for simplifying the simulation. Waves 51 were selected so that they produce a wavefront deformation of 60 nanometers. Such a value is also achieved at comparatively strong schlieren. To obtain such a wavefront deformation, the waves have a height (peak-to-valley) of 116 nanometers. Now, for comparison, FIGS. 6 to 8 show, in correspondence to FIGS. 2 to 4, the calculated focuses of lens system 1 with a lens 5 that was modified as shown in FIG. 5.

As can be seen from FIGS. 6 to 8, all focuses 150, 160, 170 are significantly enlarged as compared to the focuses shown in FIGS. 2, 3, 4. Already focus 150 of paraxial ray beam 15 is widened by more than two and a half times in the direction transverse to the longitudinal direction of waves 51.

Therefore, it is generally favorable for the optical properties of the lens system according to the invention to select a low schlieren glass. Therefore, according to one embodiment of the invention, the glass of the first lens 5 is selected such that the wavefront error caused by schlieren is at most 30 nanometers, preferably at most 15 nanometers.

If the glass comprises manufacture-related schlieren, such a value may be obtained, for example, by sorting out lenses or already preforms, such as glass gobs for the blank molding of the lens. However, it is particularly desirable to avoid excessive streaking already during manufacture.

Accordingly, the invention also relates to a method for producing a lens system as described in the present application, the method comprising the steps of:
melting a copper ions containing glass;
producing glass gobs from the glass melt;
producing first lenses 5 with a positive focal length, preferably in form of biconvex lenses, from the glass gobs;
assembling a lens system 1 using a second lens 7 that has a negative focal length and an Abbe number which is smaller than the Abbe number of the first lens 5, so that
the difference between the Abbe numbers of the first lens 5 and the second lens 7 is at least 15.

The gobs are preferably prepared in form of near net shaped preforms. For this purpose, balls having a diameter from 0.5 mm to 10.0 mm are especially suitable as preforms.

According to a first embodiment, the fabrication of lenses 5 from the glass gobs may be accomplished by blank molding.

According to another embodiment, the lens may be manufactured by blank molding directly from the glass melt, i.e. without using glass gobs.

According to yet another embodiment, the lenses formed from the gobs may be produced by grinding and subsequent polishing.

Additionally, again, it is advantageous in this method to use phosphate glasses, preferably fluorophosphate glasses. These types of glass proved to be particularly suitable to decrease the number and intensity of schlieren, in spite of the copper contained in the composition. Schlieren may also have a detrimental effect in the above mentioned method variation including grinding and polishing, because the schlieren may lead to surface deformations during abrasive removal of material. Also in blank molding schlieren may have a detrimental effect in terms of contour fidelity of the lens surface, since schlieren also entail local changes of the expansion coefficients. Therefore, the use of the preferred phosphate glasses and especially fluorophosphate glasses improves the optical quality of the produced lenses in several respects.

The invention also relates to the manufacturing of a camera module such as shown in FIG. 1, this manufacturing process being based on the above-mentioned method and further comprises an assembly of lens system 1 and semiconductor array sensor 10. In this case, the assembly of lens system 1 and the assembly of camera module 3 do not necessarily need to be performed in succession. It is also possible for the individual lenses, in the example shown in FIG. 1 lenses 5, 7, 8, 9, to be mounted to semiconductor array sensor 10 successively one by one, or in groups.

Lens 5 of the lens assembly according to the invention has at least one curved refractive surface, because of its positive focal length. Therefore, the path of a light beam not only depends on the angle of incidence to the optical axis 20, but also on the point of incidence on the lens. Normally one would expect, therefore, that the transmission through the lens depends on the angle to the optical axis.

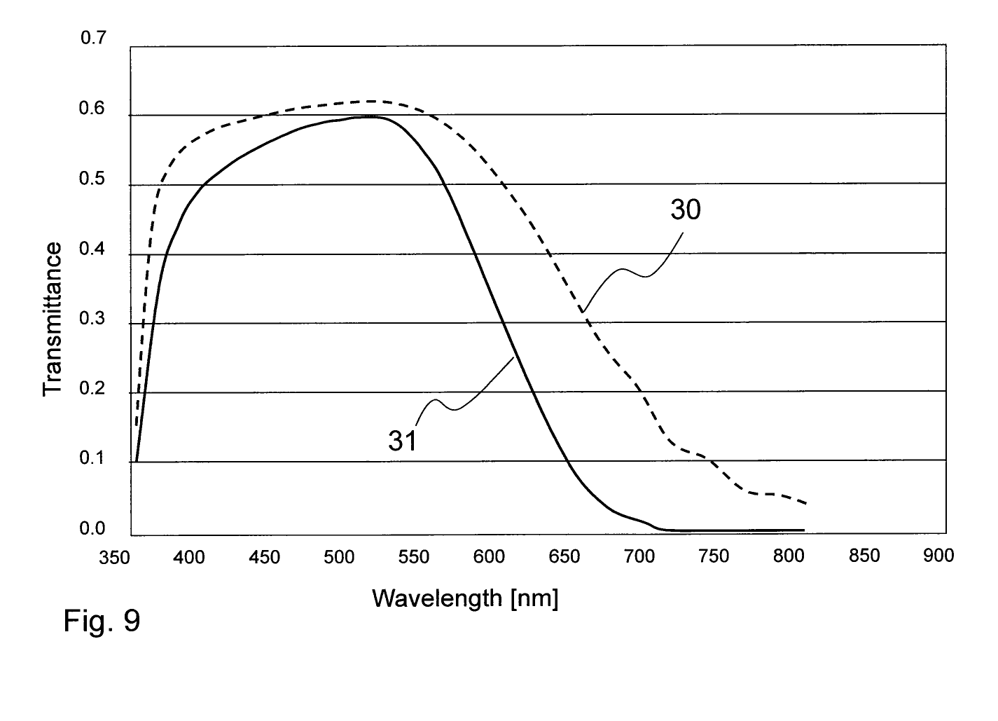

However, surprisingly, it has been found that there is no appreciable dependence of the transmission from the incident angle to the optical axis, as with the conventional arrangement of a blue glass as an infrared filter in form of a thin sheet in front of the semiconductor array sensor. However, with the same content of copper ions the transmission curve as a whole changes, since lens 5 is typically thicker than a conventional blue glass infrared filter. FIG. 9 shows a comparison of the spectral transmission curves for a lens according to the invention and a blue glass sheet in front of the sensor made of the same glass. The glass is again the above mentioned fluorophosphate glass having an Abbe number of 64. The curve denoted by reference numeral 30 represents the transmission curve for a blue glass sheet as has hitherto been used as an infrared filter element. For comparison, the curve denoted by reference numeral 31 represents the spectral transmission curve for a lens 5 as used for a lens system 1 according to the invention. The individual transmission characteristics for the different light beams 15, 16, 17 are not shown because the differences are very small and the individual curves nearly overlie each other, so that the differences cannot be illustrated in the diagram of FIG. 9. Accordingly, with the same amount of copper oxide, transmission through lens 5 is less than through a corresponding blue glass filter sheet.

An advantageous effect of the arrangement according to the invention, on the other hand, is that the infrared component is suppressed even more effectively. For example, in this exemplary embodiment, transmission above 700 nanometers is virtually zero, while for a blue glass filter sheet there is a measurable transmission existent even at a light wavelength of 800 nanometers. In order to not reduce transmission in the visible spectral range too much, lower copper oxide contents of the phosphate or fluorophosphate glasses are preferred for lens 5, without being limited to the particular arrangement of the lens system of FIG. 1.

By varying the copper oxide contents, a transmission curve is to be obtained with the following features: in a range from 400 nm to 550 nm the transmission of the filter is greater than 80%, at 650 nm the transmission is less than 55%, and at 850 nm the transmission is less than 10%.

If, for example, a lens 5 of 1 millimeter thickness is provided and is intended to have the same transmission as a filter sheet of 0.3 millimeter thickness, a concentration of Cu ions lower by a factor of 1/0.3=3.33 may be used for the filter glass of the lens.

As can be seen from transmission curves 30, 31, the copper ions contained in the glass also affect the transmission in the visible spectral range. It is therefore surprising that such a glass permits to achieve high Abbe numbers, making it possible to combine a lens of this glass with a lens of another glass and of a lower Abbe number in a manner that an achromatic lens system is obtained.

### LIST OF REFERENCE NUMERALS

1 Lens System

3 Camera module

5 First lens with positive focal length

7 Second lens with negative focal length

8, 9 Lens

10 semiconductor array sensor

15, 16, 17 Beam of light rays

20 Optical axis

30, 31 Transmission curves

50 Lens surface of 5

51 Waves on 50

149 Diffraction-limited focus

150 Focus of 15

160 Focus of 16

170 Focus of 17

What is claimed is:

1. A lens system for a camera module, comprising:
an achromatic lens system having at least two lenses, wherein the at least two lenses include a first lens with a positive focal length and a second lens with a negative focal length, the first lens being made of copper ions containing glass that absorbs infrared light and functions as an infrared filter, the second lens having an Abbe number that is smaller than an Abbe number of the first lens with a difference between the Abbe numbers of the first and lenses being at least 15.

2. The lens system as claimed in claim 1, wherein first lens comprises glass having an Abbe number of at least 55.

3. The lens system as claimed in claim 1, wherein the first lens comprises a low schlieren glass so that wavefront error caused by schlieren is not greater than 30 nanometers.

4. The lens system as claimed in claim 1, wherein the first lens comprises a low schlieren glass so that wavefront error caused by schlieren is not greater than 15 nanometers.

5. The lens system as claimed in claim 1, wherein the first lens is made of copper ions containing phosphate or fluorophosphate glass.

6. The lens system as claimed in claim 1, wherein the second lens has a focal length with an absolute value that is smaller than a focal length of the first lens.

7. The lens system as claimed in claim 1, wherein the second lens is made of a flint glass.

8. The lens system as claimed in claim 1, wherein the Abbe number of the second lens has a value of not more than 40.

9. The lens system as claimed in claim 1, wherein the first lens is arranged at a light entrance side of the system.

10. A camera module, comprising:
a semiconductor array sensor; and
an achromatic lens system arranged in front of the semiconductor array sensor, the achromatic lens system having at least two lenses, wherein the at least two lenses include a first lens with a positive focal length and a second lens with a negative focal length, the first lens being made of copper ions containing glass that absorbs infrared light and functions as an infrared filter, the second lens having an Abbe number that is smaller than an Abbe number of the first lens with a difference between the Abbe numbers of the first and lenses being at least 15.

11. The camera module as claimed in claim 10, further comprising at least one further lens in addition to the first and the second lens, wherein the first and the second lenses directly follow one another along the optical path.

12. The camera module as claimed in claim 10, further comprising at least two further lenses in addition to the first and the second lens, wherein the first and the second lenses directly follow one another along the optical path.

13. The camera module as claimed in claim 10, wherein the first lens forms an entrance lens of the lens system.

14. A method for producing a lens system, comprising the steps of:
melting a copper ions containing glass to form a glass melt;
producing glass gobs from the glass melt;
producing first lenses having a positive focal length from the glass gobs; and
assembling the lens system using one of the first lenses and a second lens that has a negative focal length and an Abbe number which is smaller than an Abbe number of the first lens with a difference between the Abbe numbers of the first and lenses being at least 15.

15. The method as claimed in claim 14, wherein the step of producing the first lenses comprises forming biconvex lenses from the glass gobs.

16. The method as claimed in claim 14, wherein the step of producing the glass gobs from the glass melt comprises forming the glass gobs into a ball having a diameter from 0.5 millimeters to 10.0 millimeters.

17. The method as claimed in claim 16, wherein the step of producing the first lenses from the glass gobs comprises blank molding.

18. The method as claimed in claim 16, wherein the step of producing the first lenses from the glass gobs comprises grinding and subsequent polishing.

19. The method as claimed in claim 14, wherein the step of producing the first lenses comprises blank molding directly from the glass melt.
